(19) United States
(12) Patent Application Publication
(10) Pub. No.: US 2015/0117238 A1
(43) Pub. Date: Apr. 30, 2015

(54) Wireless Communication Terminal and Server and Methods Thereof for Inter-RAT Cell Measurement Reporting

(71) Applicants: Fredric Kronestedt, Bromma (SE); Håkan Persson, Solna (SE); Joachim Sachs, Stockholm (SE)

(72) Inventors: Fredric Kronestedt, Bromma (SE); Håkan Persson, Solna (SE); Joachim Sachs, Stockholm (SE)

(73) Assignee: Telefonaktiebolaget L M Ericsson (publ), Stockholm (SE)

(21) Appl. No.: 14/398,146

(22) PCT Filed: May 3, 2012
(86) PCT No.: PCT/SE2012/050456

§ 371 Date: Oct. 31, 2014

(51) Int. Cl. H04W 24/08

(52) U.S. Cl. CPC H04W 24/08; H04W 84/12
USPC 370/252

(57) ABSTRACT

The present invention relates to a method of a wireless communication terminal (101). The method comprises detecting whether the terminal is in range of a wireless local network. The method also comprises measuring, while the terminal is in range of said local network, signal quality of a cell (103) of a first cellular radio access network (105). The cell uses a first radio access technology (RAT). The method also comprises sending information about the measured signal quality to a server(104). The information is sent via a second radio access technology (RAT) which is different from the first RAT.

### TECHNICAL FIELD

The present disclosure relates to a wireless communication terminal, a network server, methods thereof and computer programs and computer program products therefore.

### BACKGROUND

Mobile broadband services are used at indoor locations to a large extent. Operators report that 70-80% of traffic is generated indoor. Indoor locations often have poor coverage from macro sites due to high building penetration losses (20-30 dB is common). Hence in some buildings there is a need to improve coverage for cellular radio systems. Some operators deploy WiFi at indoor locations (e.g. in public areas) to boost coverage. It is also common that fixed broadband subscribers use WiFi in their homes (in residential areas). Most smartphones can communicate using both WiFi and cellular technologies like Global System for Mobile Communications (GSM), Wideband Code Division Multiple Access (WCDMA) and Long Term Evolution (LTE).

To save cost, the WiFi sites can be reused to improve cellular coverage by deploying a multi-standard base station at the WiFi site that supports both WiFi and cellular technologies.

To verify coverage and quality of service (QoS), operators typically run drive tests in a cellular network. In Third Generation Partnership Project (3GPP), measurements and reporting procedures have been developed to minimize the need of drive tests. A user equipment (UE) can be requested to report signal strength and signal quality with its position (if available) to the radio access network and OAM (operations, administration and management) network. This, however, does not take WiFi deployment into consideration. Measurements done when connected to Universal Mobile Telecommunication System (UMTS) and LTE for other cellular radio access technologies GSM and code division multiple access 2000 (CDMA2000) are measured if available/configured. In 3GPP cellular systems, the measurement architecture/concept is a control plane solution where the radio access network (RAN) configures the UE and then the network receives measurements and forwards them (including any possible extra information from uplink (UL) measurements performed in network side) to a Trace Collection Entity (TCE) from which the OAM network can analyse the measurements.

### SUMMARY

It is a problem to predict and detect where there is bad or no indoor coverage by cellular 3GPP systems. It could be done by walk-testing (measure signal strength) building by building but this is very expensive and time consuming and/or by using the 3GPP defined functionality for minimizing drive tests (MDT) but positioning data may not be available or reliable. In order to reuse WiFi sites to improve cellular indoor coverage, there is a need to understand if there is bad or no cellular coverage at each individual WiFi site. To save costs, a base station of a cellular communication system is preferably only deployed where there is a need to improve cellular coverage.

It is an objective of the present disclosure to alleviate this problem of the prior art.

According to an aspect of the present disclosure, there is provided a method of a wireless communication terminal. The method comprises detecting whether the terminal is in range of a wireless local network. The method also comprises measuring, while the terminal is in range of said local network, signal quality of a cell of a first cellular radio access network (RAN). The cell uses a first radio access technology (RAT). The method also comprises sending information about the measured signal quality to a server. The information is sent via a second radio access technology (RAT).

According to another aspect of the present disclosure, there is provided a communication terminal for wireless communication. The terminal comprises a processor. The processor is configured for detecting whether the terminal is in range of a wireless local network. The processor is also configured for measuring, while the terminal is in range of said network, signal quality of a cell of a first cellular radio access network (RAN). The cell uses a first radio access technology (RAT). The processor is also configured for preparing a radio message comprising information about the measured signal quality. The message is intended to be sent to a server via a second radio access technology (RAT). The terminal also comprising a transmitter configured for sending the message to the server.

According to another aspect of the present disclosure, there is provided a communication terminal for wireless communication. The terminal comprises means for detecting whether the terminal is in range of a wireless local network. The terminal also comprises means for measuring, while the terminal is in range of said local network, signal quality of a cell of a first cellular radio access network (RAN). The cell in this case uses a first radio access technology (RAT). The terminal also comprises means for sending information about the measured signal quality to a server, via a second radio access technology (RAT).

Any terminal discussed herein may be configured for performing any method of a wireless communication terminal discussed herein.

According to another aspect of the present disclosure, there is provided a computer program product comprising computer-executable components for causing a terminal for wireless communication to perform any method of a wireless communication terminal discussed herein, when the computer-executable components are run on a processor included in the terminal.

According to another aspect of the present disclosure, there is provided a computer program comprising computer program code which is able to, when run on a terminal for wireless communication, cause the terminal to perform any method of a wireless communication terminal discussed herein. Thus the terminal may be caused to detect whether the terminal is in range of a wireless local network. The terminal may also be caused to measure, while the terminal is in range of said network, signal quality of a cell of a first cellular radio access network (RAN), wherein the cell uses a first radio access technology (RAT). The terminal may also be caused to send information about the measured signal quality to a server, via a second radio access technology (RAT).

According to another aspect of the present disclosure, there is provided a computer program product comprising a computer program according to the computer program aspect above. The computer program product also comprises a computer readable means on which the computer program is stored.

According to another aspect of the present disclosure, there is provided a method of a server. The method comprises sending a request to a wireless communication terminal for the terminal to detect whether said terminal is in range of a wireless local network, and for the terminal to, if it has been detected that the terminal is in range of the wireless local network, measure a signal quality of a cell of a cellular radio access network (RAN). The method also comprises receiving information about the measured signal quality from the terminal. The method also comprises storing said information.

According to another aspect of the present disclosure, there is provided a server. The server comprises a transmitter configured for sending a message to the terminal. The server also comprises a receiver configured for receiving information about measured signal quality from a terminal. The server also comprises a storage unit configured for storing said information. The server also comprises a processor. The processor is configured for preparing the message. The message comprises a request to a wireless communication terminal for the terminal to detect whether said terminal is in range of a wireless local network, and for the terminal to, if it has been detected that the terminal is in range of the wireless local network, measure a signal quality of a cell of a cellular radio access network (RAN). The processor is also configured for obtaining the information about the measured signal quality from the receiver. The processor is configured for storing the obtained information in the storage unit.

Any server discussed herein may be configured for performing any method of a server discussed herein.

It is an advantage to be able to perform signal quality measurements on a cellular radio access technology, the RAT being implemented in a cell of a RAN, within a geographical area/volume covered by a local area network, e.g. a WLAN or other local area network access point (AP). This is because it may then be possible to improve the coverage of the cellular RAN by positioning an additional base station of the RAN together with the AP. The additional base station may e.g. be a femtocell base station connected to the internet via the AP. By using a terminal, e.g. a UE, which is both able to detect whether it is within range of a local area network and able to perform quality measurements on at least one cellular RAT, it is thus possible to obtain information needed for determining whether an additional cellular base station is needed at the AP, without the need of walk testing.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments of the invention are now described, by way of example, with reference to the accompanying drawings, in which:

FIG. 1 is a schematic illustration of an embodiment of a communication system, showing how different elements discussed herein may be related to each other.

FIG. 2A is a schematic block diagram of an embodiment of a wireless communication terminal.

FIG. 2B is a schematic block diagram of an embodiment of a storage unit of the wireless communication terminal of FIG. 2A.

FIG. 3 is a schematic block diagram of an embodiment of a network server.

FIG. 4 is a schematic flow chart of an embodiment of a method of a wireless communication terminal.

FIG. 5 is a schematic flow chart of another embodiment of a method of a wireless communication terminal.

FIG. 6 is a schematic flow chart of another embodiment of a method of a wireless communication terminal.

FIG. 7 is a schematic flow chart of an embodiment of a method of a network server.

FIG. 8 is a schematic flow chart of another embodiment of a method of a network server.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

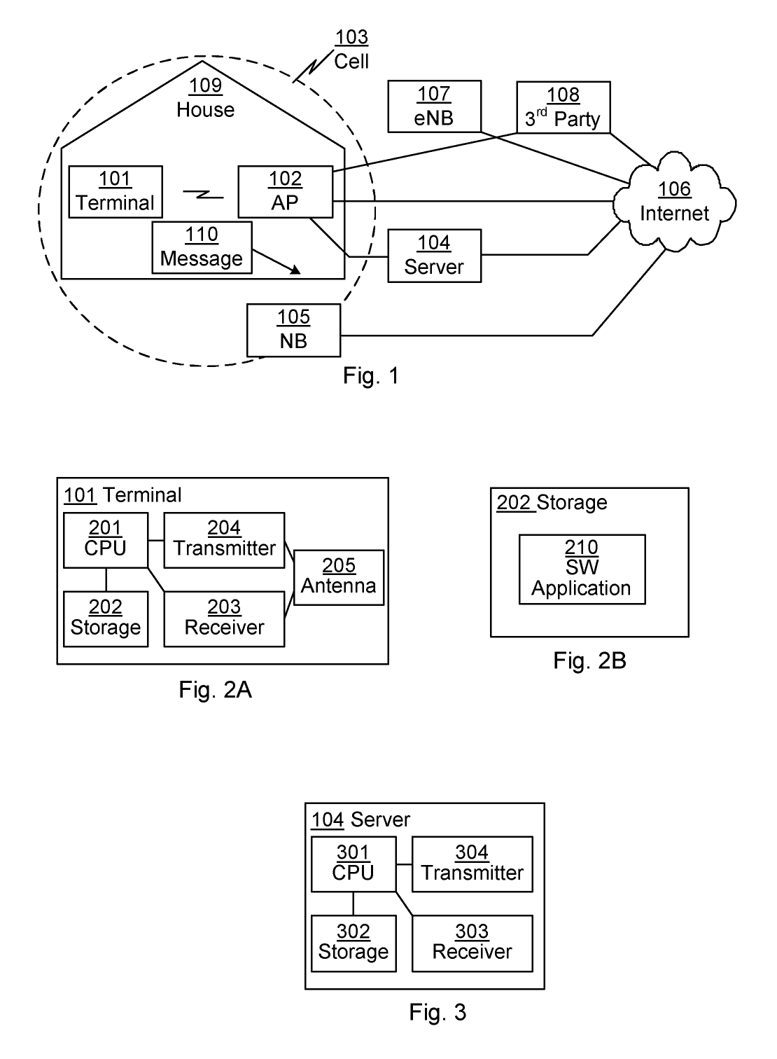

FIG. 1 illustrates a schematic overview of how different elements discussed herein relate to each other by means of an example.

A wireless local network (sometimes herein referred to as “network”), in FIG. 1 represented by the access point (AP) 102 provides wireless coverage for radio communications over a limited geographical area/volume. The local network is typically not cellular and thus only has a single AP. The AP may e.g. be used to provide improved coverage in places where a high capacity for wireless communications is desired, such as inside a house 109, e.g. a private home or in an office building. Additionally or alternatively, the AP 102 may be used to provide coverage in places where macro cells of a cellular radio communication system (in FIG. 1 represented by the Node B (NB) 105 or the enhanced Node B (eNB) 107) may provide reduced coverage e.g. du to topographical interference such as the walls of the house 109. In some embodiments, the wireless local network is a standard wireless local area network (WLAN) according to an Institute of Electrical and Electronics Engineers (IEEE) WiFi standard, but other local area networks are also alternatively contemplated, such as according to a Bluetooth standard or a Digital Enhanced Cordless Telecommunications (DECT) standard. Alternatively, the network may use an unlicensed (license exempt) communication standard. The network may e.g. operate on the radio frequency band of 2.4 GHz and/or 5 GHz (typically associated with WiFi), or alternatively the network may use unused capacity of the television bands. The wireless local network is in some embodiments operated by the same operator as is the operator of the cellular communication system on which the terminal 101 performs signal quality measurements. In other embodiments, the network is operated by a third party 108.

A wireless communication terminal 101, i.e. a communication terminal configured for wireless (radio) communication and herein also referred to just as “terminal”, is in FIG. 1 also, just as the AP 102, depicted to be inside the house 109. However, the house 109 is only an example and the present disclosure is relevant in any case where the terminal 101 is in range of the AP 102, indoors or outdoors. The terminal is able to detect whether it is in range of the wireless local network. Typically, the terminal is also able to connect to and communicate via the network, but this is not essential. The terminal may e.g. not be able to connect to the network, even if it can detect it, due to it not being authorized to connect to the network, which network may be closed e.g. be a closed subscriber group (CSG) network. The terminal is able to detect the network e.g. by a beacon signal broadcast by the AP. Alternatively, the configuration of the network may not be compatible with the terminals capabilities, whereby the terminal may not be able to connect to the network even though it can detect it. The terminal is capable of performing signal quality measurements on at least one cellular radio access technology (RAT). In some embodiments, these signal quality measurements are performed in response to the terminal 101 detecting the local network. The signal quality is measured e.g. as Reference Signal Received Power (RSRP) or Reference Signal Received Quality (RSRQ) in LTE, or received signal strength. It is not necessary that the RAT, or RAN implementing the RAT, is detectable by the terminal 101 in order for the terminal to perform the measurement on the RAT, in which case the measurement may conclude that there is no signal or that the signal is to faint for providing coverage at the geographical position of the terminal. Typically, the terminal 101 is also capable of connecting to and communicate via the cellular RAT, but this is not essential. It may thus be convenient that the terminal 101 is capable to both connect to the wireless local network and to at least one cellular RAT, whereby the terminal is multi-RAT capable. In some embodiments, the terminal 101 is capable of connecting to and communicating via a plurality of cellular RATs. The terminal is capable to perform signal quality measurement on, and possibly connect to and communicate via, at least one cellular RAT. Examples of such cellular RATs include: Global System for Mobile Communications (GSM), Universal Mobile Telecommunication System (UMTS), Long Term Evolution (LTE) Wideband Code Division Multiple Access (WCDMA), Code Division Multiple Access 2000 (CDMA2000), Interim Standard 95 (IS-95), Ultra Mobile Broadband (UMB), and High-Speed Packet Access (HSPA). Herein, non-limiting examples are given using the WCDMA/HSPA and LTE communication standards. The terminal 101 may be any terminal or user equipment (UE) able to communicate wirelessly, via radio. In some embodiments, the terminal is a mobile terminal such as a mobile phone or portable computer. In some other embodiments, the terminal is a stationary terminal such as a household appliance (fridge, freezer) or an energy management terminal.

More than one terminal 101 may be in range of the local network in which case it may be convenient to apply the embodiments of the method disclosed herein on a plurality or all of the terminals 101 in range of the AP 102.

In the embodiment of FIG. 1, two different cellular communication systems are present, each with a RAN using/implementing a RAT. Here a WCDMA/HSPA cellular system is represented by the NB 105 serving a cell 103 which generally covers an area comprising the house 109 in which the AP 102 and the terminal 101 are. However, WCDMA/HSPA is only one example and the cell 103 and the node providing it may be in accordance with any cellular radio communication standard. The NB may be connected to the internet 106. Typically, the NB is connected to a core network (not shown) via a radio network control node (not shown), whereby the NB 105 may be connected to the internet 106 via the RNC/CN to provide internet access to terminals connected to the NB. The WCDMA/HSPA cellular system of course comprises more than one NB, typically hundreds or thousands of NBs, which form cells of the communication system. Similarly, an LTE cellular communication system is represented by the eNB 107. Also the eNB 107 may be connected to the internet 106 to provide internet access to terminals connected to the eNB. The eNB 107 is connected to an LTE CN (not shown). Of course, also the LTE communication system typically comprises hundreds or thousands of eNBs which form cells of the communication system. Other cellular communication system(s) may additionally or alternatively be present in the general vicinity of the terminal 101 and AP 102, e.g. a GSM system. The terminal may or may not be capable of connecting with any one of the RATs used by the respective cellular systems.

A network server 104 is configured to receive and store information sent to it by the terminal 101. The server 104 may be positioned anywhere, and be connected to any of the elements shown in FIG. 1, as long as it is able to receive communications from the terminal 101. In an embodiment the server can receive the information via the wireless local network and AP 102, in another embodiment the server can receive the information via the WCDMA/HSPA RAT and NB 105, in another embodiment the server can receive the information via the LTE RAT and eNB 107, and in other embodiments the server 104 can receive the information via another RAT not shown in FIG. 1. In the embodiment of FIG. 1, the server 104 is connected to the AP 102 and to the internet 106. Via the internet 106, the server 104 is also connected to the NB 105 as well as to the eNB 107. In some embodiments, the server 104 is managed by the operator of the cellular communication system on which the terminal 101 performs signal quality measurements and, optionally, other measurements. In some embodiments, the information collected by the server 104 is used by the operator of the cellular system measured on, to determine whether the coverage and/or capacity of the cellular system needs to be improved at the volume covered by the local network. The server 104 is in some embodiments part of the cellular communication system (e.g. the cellular system comprising the NB 105 and the cell 103) on which the terminal 101 performs measurements. In exemplary embodiments, the server 104 is positioned/comprised in a RAN, CN or OAM of the cellular communication system, or on the internet. The server 104 may have a trace collection entity (TCE) as defined in 3GPP.

In some embodiments, the server 104 is managed by a third party 108. In this case, the terminal 101 may be configured/instructed to perform measurements on all frequencies the terminal is capable of measuring on (signal quality and optionally other measurements). This is in contrast to the case when the server is managed by an operator of a cellular communication system, when the operator may only configure/instruct the terminal 101 to perform measurements on the frequencies used by the operator and, possibly, on frequencies of other operators which the operator cooperates with e.g. in case of national roaming or network sharing. The third party 108 may be the provider of the wireless local network, in which case the terminal 101 may be instructed to perform the measurements upon connecting to the network, whereby the information of the measurements can be sent to the server 104 via the AP 102, both the AP 102 and the server 104 being managed by the third party 108, possibly via the internet 106.

As indicated in FIG. 1, information about the measurements performed by the terminal 101 on the cell 103 are sent to the server 104 in a radio communication message 110 via the AP 102 or via a node (here the eNB 107 or NB 105) of a cellular communication system. In some embodiments, the message no is sent via a cellular communication system 107 not comprising the cell 103, i.e. the second RAT is different from the first RAT. Thus, measurements are done on one RAT and the information about the measurement is sent via a different RAT. Alternatively, the second RAT may be the same as the first RAT, whereby the measurements are done on one

RAT and the information about the measurements are then sent via the same RAT. The information may be sent directly, or first be logged in the terminal and then sent at a later time. Depending on the situation and on via which RAT the terminal is connected, it may be convenient to send the information via the same RAT on which the measurements were made, or via a different RAT. The present disclosure may be used for minimization of drive tests (MDT), for which there are two different schemes defined in 3GPP standards 1) Logged MDT and 2) Immediate MDT. Logged MDT is performed in idle mode (IDLE user equipment (UE)/terminal state (RRC_IDLE) where RRC is the radio resource control in evolved Universal Mobile Telecommunications System Terrestrial Radio Access Network (E-UTRAN), or in IDLE mode (RRC_IDLE), CELL_PCH and URA_PCH states in UTRAN) whereby measurements are performed and logged until the logging duration timer stops or expires. Measurements can be reported to a network with same RAT as measured by sending an indication to the network when the terminal enters active mode (establishing a connection). This will then allow the network to retrieve measurements. Thus, the signal quality measurements may be performed on the first RAT when the terminal 101 is in idle mode, and the information about the measurement may later be sent via the same RAT when the terminal is in active (connected) mode. In contrast, immediate MDT is done during “active” mode, i.e. the terminal 101 is in RRC connected state. The signal quality is measurements on the RAT via the terminal is connected and the information is sent “immediately” over the established connection and thus not logged. The latest detailed description of MDT can be found in 3GPP TS 37.320.

FIG. 2A schematically illustrates an embodiment of a wireless communication terminal 101 of the present disclosure. The terminal 101 comprises a processor or central processing unit (CPU) 201. The processor 201 may comprise one or a plurality of processing units in the form of microprocessor(s). However, other suitable devices with computing capabilities could be used, e.g. an application specific integrated circuit (ASIC), a field programmable gate array (FPGA) or a complex programmable logic device (CPLD). The processor 201 is configured to run one or several computer program(s) or software stored in a storage unit or memory 202. The storage unit is regarded as a computer readable means and may e.g. be in the form of a Random Access Memory (RAM), a Flash memory or other solid state memory, or a hard disk. The processor 201 is also configured to store data in the storage unit 202, as needed. The terminal 101 also comprises a transmitter 204, a receiver 203 and an antenna 205, which may be combined to form a transceiver or be present as distinct units within the terminal 101. The transmitter 204 is configured to cooperate with the processor to transform data bits to be transmitted over a radio interface to a suitable radio signal in accordance with the RAT used by the RAN via which the data bits are to be transmitted. The receiver 203 is configured to cooperate with the processor 201 to transform a received radio signal to transmitted data bits. The antenna 205 may comprise a single antenna or a plurality of antennas, e.g. for different frequencies and/or for MIMO (Multiple Input Multiple Output) communication. The antenna 205 is used by the transmitter 204 and the receiver 203 for transmitting and receiving, respectively, radio signals.

FIG. 2B schematically illustrates an embodiment of the storage unit 202 shown in FIG. 2A. According to this embodiment, the storage unit contains a software application 210 stored in the storage unit. The software application is configured to be run on the processor 201 for configuring the processor for performing a method of the terminal 101 discussed herein. The software application may have been pre-installed in the storage unit upon manufacture of the terminal 101. Alternatively, the software application 210 may have been downloaded and installed to the storage unit 202 by a user of the terminal 101 in cooperation with the processor 201. In some embodiments, the software application 210 is provided by the operator of the cellular communication system on which the terminal 101 performs measurements. The operator may then have pre-installed the software application on the terminal 101 before the terminal is provided to a user of the terminal, e.g. sold, or the installation may be done by the user e.g. as a requirement for being allowed to connect to the cellular system of the operator. In some embodiments, the software application is provided by a third party 108, e.g. as a downloadable client “app” application. The third party 108 may then collect information provided by means of the client application 210 in the server 104 and sell or otherwise use it.

FIG. 3 schematically illustrates an embodiment of the server 104. The server 104 comprises a processor or CPU 301. The processor 301 may comprise one or a plurality of processing units in the form of microprocessor(s). However, other suitable devices with computing capabilities could be used, e.g. an application specific integrated circuit (ASIC), a field programmable gate array (FPGA) or a complex programmable logic device (CPLD). The processor 301 is configured to run one or several computer program(s) or software stored in a storage unit or memory 302. The storage unit is regarded as a computer readable means and may e.g. be in the form of a Random Access Memory (RAM), a Flash memory or other solid state memory, or a hard disk. The processor 301 is also configured to store data in the storage unit 302, as needed. The server 104 also comprises a transmitter 304 and a receiver 303, which may be combined to form a transceiver or be present as distinct units within the server 104. The transmitter 304 and the receiver 303 are configured for wired or wireless communication. The transmitter 304 is configured to cooperate with the processor to transform data bits to be transmitted to a suitable signal in accordance with the communication standard used by the server 104. The receiver 303 is configured to cooperate with the processor 301 to transform a received signal to transmitted data bits, which are optionally then stored in the storage unit 302.

The storage unit 302 is configured to cooperate with the processor 301 for storing information sent to the server 104 by the terminal 101. This stored information may comprise any of:
Signal quality information, based on the measurements made by the terminal 101 on a cell 103 of a RAN node 105 of a cellular communication system.
Position information, based on a determination of a position of the terminal 101 when the terminal measured the signal quality. The position may be determined by the terminal 101 e.g. by means of a GPS functionality of the terminal 101. Additionally or alternatively, a position may be determined by obtaining some cell identification number or code of the AP 102 or of a cellular communication system. Additionally or alternatively, a standard positioning technique of a cellular communication system may be used, such as Observed Time Difference of Arrival (OTDOA) or other triangulation. This information may be used to determine where the wireless local network is and/or where within range of said network the terminal 101 is located when performing the measurements on the cell 103. An additional or alternative way of obtaining at least part of the position information is that the server 104 itself looks up the position (e.g. street address) of the AP 102 and/or cellular node 107 via which the terminal 101 sends the quality information, and any other information, by the IP number of the AP 102 or cellular node 107.
Capability information, based on the capabilities of the terminal 101.

Such capabilities may be any of which RATs are supported by the terminal; frequency band(s) the terminal is able to measure on; number of antennas 105 used by the terminal; channel configurations supported by the terminal; and interference cancellation, if any, the terminal is able to use. This information may be needed to interpret the signal quality measurements. For example, if a cellular communication system is not detected by the terminal 101, this may be because there is no coverage or it may be because the capabilities of the terminal does not enable it to measure on the cellular system.
Cell type information, based on a determination of what type of cell the measured on cell 103 is. The cell types include but are not limited to macrocell, microcell, picocell or femtocell. This information may be interesting when deciding whether the cellular system coverage should be improved at the local network.
Cell configuration information, based on a determination of the configuration of the measured on cell 103. Cell configurations include but are not limited to: open subscriber group cell, closed subscriber group (CSG) cell, hybrid cell (e.g. giving priority to subscribing terminals 101 but not closed to non-subscribing terminals), multimedia broadcast multicast service (MBMS) cell, and traffic volume capacity offered by the cell (UL and/or DL). This information may also be interesting when deciding whether the cellular system coverage should be improved at the local network.
Terminal traffic volume information, based on a determination/measurement of traffic volume (e.g. Mbits of data) sent or received by the terminal 101 during a time period (pre-determined or ad hoc), during which time period the terminal 101 is in range of the wireless local network. This information provides an indication of the amount of traffic which is desired in the volume covered by the network, which traffic amount it may be desired to be handled by the cellular communication system measured on.

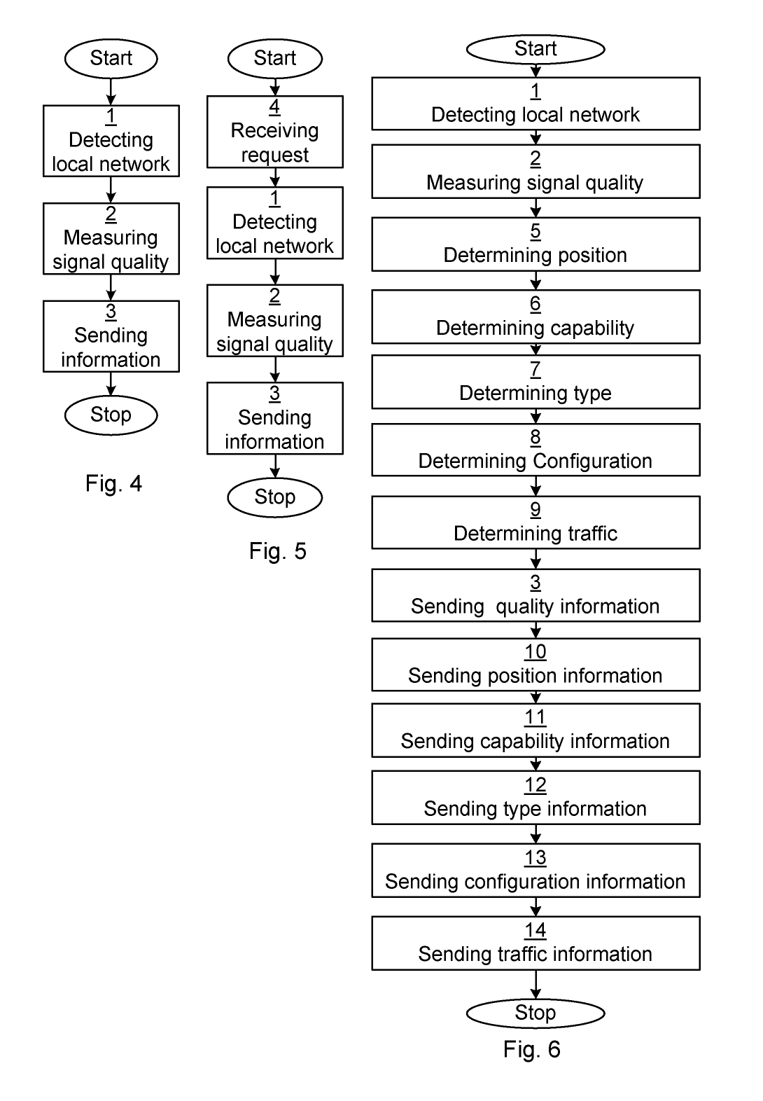

FIG. 4 illustrates an embodiment of a method of the present disclosure. The terminal 101 detects 1 whether the terminal is in range of a wireless local network. The terminal may be connected to the network or the terminal may have detected a beacon signal or other broadcast from the network AP 102, whereby the terminal may conclude that it is in range of the network. While the terminal is in range of the network, the terminal 101 measures 2 a signal quality of a cell 103 of a first cellular RAN 105, said cell using a first radio access technology, RAT. The measuring 2 may have been automatically triggered by the detection 1 that the terminal is in range of a wireless local network. Typically, the terminal 101 is not connected to the cell 103, but performs a measurement on the signal quality thereof. The terminal 101 then sends 3 information about the measured 2 signal quality to the server. This information may e.g. include the measured signal strength or RSRP and is sent in a radio message 110. The information is sent via a second RAT, which may be different from the first RAT, i.e. the information is not sent via the cellular communication system comprising the cell 103 on which the quality measurement was performed, or the second RAT may be the same as the first RAT (as discussed above in relation to FIG. 1). In some embodiments, the second RAT is implemented by the wireless local network. It may be convenient to sent the information via the network, especially if the terminal is connected to the network. Also, as further discussed herein, the operator of the network may also manage the server 104, why the server 104 may be connected to the AP 102 facilitating sending of the information there between. In some other embodiments, the second RAT is implemented by a second cellular RAN, in FIG. 1 represented by the eNB 107. This may be convenient if the terminal 101 is already connected to the second cellular RAN 107 and/or if the operator of the second cellular RAN is also the operator of the communication system comprising the cell 103 on which the measurements are made and/or also manages the server 104.

FIG. 5 illustrates another embodiment of a terminal method of the present disclosure. In this embodiment, the terminal 101 wirelessly receives 4 a request for performing the measurement 2 as in FIG. 4. This request may have been sent by the server 104 via a RAT of the wireless local network or a cellular communication system to which the terminal 101 is connected. In some embodiments, the request activates a software 210 in the terminal 101 which triggers the quality measurement 2 as soon as a wireless local network is detected 1 as in FIG. 4. In some other embodiments, the request may directly trigger the quality measurements 2. Thus, the request may be received 4 before or after the detecting 1 of a network. The information is then sent 3 as in FIG. 4.

FIG. 6 illustrates another embodiment of a terminal method of the present disclosure. The local network is detected 1, the signal quality is measured 2 and the information about the signal quality is sent 3, in accordance with the discussion in respect of FIG. 4. Additionally, one or several other determinations or measurements are made by the terminal 101 and information thereof is sent to the server 104. The different informations (discussed below) may conveniently be sent to the server 104 in the same message 110, but may alternatively be sent in separate messages. The order in which the terminal 101 performs the different determinations/measurements 2 and 5-9 (discussed below) is not critical and they may be performed in any order or in parallel. The method may comprise determining 5 a position of the terminal 101 when the signal quality is measured 2, and then sending 10 information about the determined 5 position to the server 104. Additionally or alternatively, the method may comprise determining 6 at least one capability of the terminal 101, and then sending 11 information about said at least one capability of the terminal 101 to the server 104. Additionally or alternatively, the method may comprise determining 7 a type of the cell 103, from the group consisting of a macrocell, microcell, picocell or femtocell, and then sending 12 information to the server 104 about the determined 7 type.

Additionally or alternatively, the method may comprise determining 8 at least one configuration of the cell 103, from the group consisting of an open subscriber group cell, a closed subscriber group (CSG) cell, a hybrid cell, a multimedia broadcast multicast service (MBMS) cell, and traffic volume capacity offered by the cell, and then sending 13 information about the determined 8 configuration of the cell 103 to the server 13. Additionally or alternatively, the method may comprise determining 9 an amount of uplink and/or downlink traffic sent and/or received by the terminal 101 during a time period while the terminal is in range of the wireless local network, and then sending 14 information about the determined traffic amount to the server 104. The information sent by the terminal 101 to the server 104 thus comprises Signal quality information, based on the measurements made by the terminal 101 on a cell 103 of a RAN node 105 of a cellular communication system. Additionally, the information sent to the server 104 by the terminal 101 may comprise at least one of:
Position information, based on a determination of a position of the terminal 101 when the terminal measured the signal quality. The position may be determined by the terminal 101 e.g. by means of a GPS functionality of the terminal 101. Additionally or alternatively, a position may be determined by obtaining some cell identification number or code of the AP 102 or of a cellular communication system. Additionally or alternatively, a standard positioning technique of a cellular communication system may be used, such as Observed Time Difference of Arrival (OTDOA) or other triangulation. Additionally or alternatively, the signal strength of the local network is measured to provide an indication of the distance between the terminal 101 and the AP, which also provides position information. This information may be used to determine where the wireless local network is and/or where within range of said network the terminal 101 is located when performing the measurements on the cell 103. An additional or alternative way of obtaining at least part of the position information is that the server 104 itself looks up the position (e.g. street address) of the AP 102 and/or cellular node 107 via which the terminal 101 sends the quality information, and any other information, by the IP number of the AP 102 or cellular node 107.
Capability information, based on the capabilities of the terminal 101. Such capabilities may be any of which RATs are supported by the terminal; frequency band(s) the terminal is able to measure on;
number of antennas 105 used by the terminal; channel configurations supported by the terminal; and interference cancellation, if any, the terminal is able to use. This information may be needed to interpret the signal quality measurements. For example, if a cellular communication system is not detected by the terminal 101, this may be because there is no coverage or it may be because the capabilities of the terminal does not enable it to measure on the cellular system.
Cell type information, based on a determination of what type of cell the measured on cell 103 is. The cell types include but are not limited to macrocell, microcell, picocell or femtocell. This information may be interesting when deciding whether the cellular system coverage should be improved at the local network.
Cell configuration information, based on a determination of the configuration of the measured on cell 103. Cell configurations include but are not limited to: open subscriber group cell, closed subscriber group (CSG) cell, hybrid cell (e.g. giving priority to subscribing terminals 101 but not closed to non-subscribing terminals), multimedia broadcast multicast service (MBMS) cell, and traffic volume capacity offered by the cell (UL and/or DL). This information may also be interesting when deciding whether the cellular system coverage should be improved at the local network.
Terminal traffic volume information, based on a determination/measurement of traffic volume (e.g. Mbits of data) sent or received by the terminal 101 during a time period (pre-determined or ad hoc), during which time period the terminal 101 is in range of the wireless local network. This information provides an indication of the amount of traffic which is desired in the volume covered by the network, which traffic amount it may be desired to be handled by the cellular communication system measured on. Often, not only one terminal 101 generates traffic amount in an area, why it is desirable to obtain information from all terminals 101 in range of the AP 102.

The method of the terminal 101 discussed herein, e.g. a method of any of the embodiments discussed in respect of any of the FIGS. 1-3, may be controlled by a computer program or software application 210, stored in the storage unit 202 and run on the processor 201. In some embodiments, the software application 210 can be turned off or on by a user of the terminal 101. In some embodiments, the software application 210 can be turned on and off by an operator of RAT the terminal 101 is connected via, such as the RAT of the local network, or the RAT of a cellular communication system, which the terminal 101 is connected to. The software application may e.g. be turned on or activated by receiving 4 the request discussed in relation to FIG. 5. The software application may e.g. trigger the measurement(s)/detection(s) when the terminal detects 1 the local network, or it may trigger the measurement(s)/detection(s) at a suitable time while the terminal 101 is in range of the network. In some embodiments, the software application may prompt the user of the terminal 101 for permission to perform the measurement(s)/detection(s) before performing them as a result of a positive input from the user. In some embodiments, the OAM system configures and controls the terminal 101 to perform the method. Alternatively, the method may be directly controlled by e.g. the server 104, via requests and other instructions sent to the terminal 101.

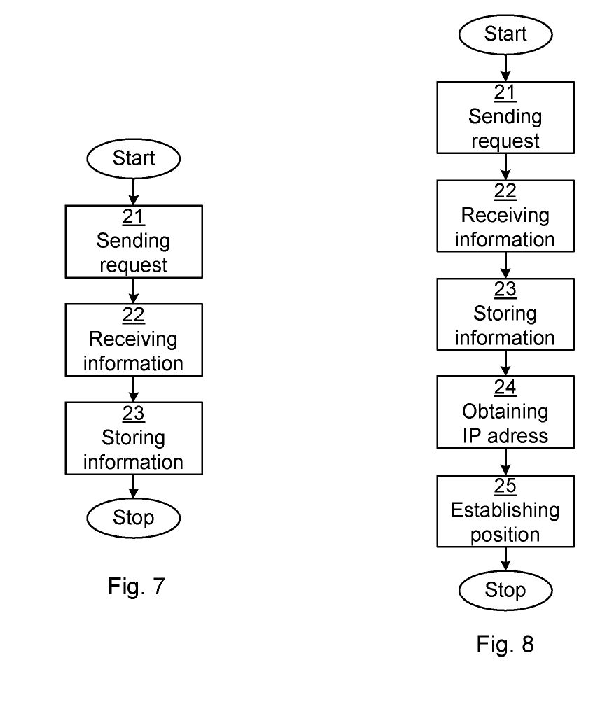

FIG. 7 illustrates an embodiment of a method of the sever 104. The server sends 21 a request to the wireless communication terminal 101 for the terminal to detect 1 whether said terminal is in range of a wireless local network, and for the terminal 101 to, if it has been detected 1 that the terminal is in range of the wireless local network, measure 2 a signal quality of the cell 103 of a cellular radio access network (RAN) 105. Thus, the sever 104 sends 21 a request to the terminal 101 for the terminal to perform the method of the terminal discussed herein. The server 104 then receives 22 information about the measured 2 signal quality from the terminal 101. This is the information and optionally informations sent by the terminal 101 as discussed herein. The server 104 then stores 23 the received information.

FIG. 8 illustrates another embodiment of a method of the sever 104. The server sends 21 a request, receives 22 information and stores 23 the received information as discussed in respect of FIG. 7. In the embodiment of FIG. 8, the server 104 additionally obtains an IP address of the AP 102 of the wireless local network. The IP address may be obtained by the server 104 communicating with the AP 102, e.g. if the information is sent to the server 104 via the AP 102. The server 14 can then establish 25 a position of the access point 102 based on the IP address, e.g. by geo-locating.

A computer program product of the present disclosure comprises a computer readable medium comprising a computer program in the form of computer-executable components. The computer program/computer-executable components may be configured to cause a device such as the terminal 101 or the server 104 to perform an embodiment of the method of the terminal or the server. The computer program/computer-executable components may be run on the processing unit 201 or 301 of the terminal or server for causing the device to perform the method. The computer program product/computer readable medium may e.g. be comprised in a storage unit or memory 202 or 302 comprised in the terminal or server and associated with the processing unit 201 or 301. Alternatively, the computer program product/computer readable medium may be, or be part of, a separate, e.g. mobile, storage means, such as a computer readable disc, e.g. CD or DVD or hard disc/drive, or a solid state storage medium, e.g. a RAM or Flash memory.

### EXAMPLE 1

The following steps are involved:

1. A client software application—server solution (i.e. application 210 installed in the terminal 101) is applied.

2. The application 210 can be turned off and on either by a user of the terminal 101 or by request from the server 104, operator of the cellular communication system comprising the cell 103 to be measured on, or from similar entity.

3. The client software application 210 orders the terminal 101 to measure 2 3GPP bearers/cells (signal strength or lack of signal strength). The trigger of starting measurements is when a WiFi network is detected 1. In addition, WiFi 102 signal strength can also be measured.

4. The client software application 210 orders terminal 101 to measure/determine 5-9 additional data such as:

Position (GPS, cell-id), Offered traffic over WiFi.

5. The client software application 210 sends 3, 10-14 informations over WiFi to server 104 that stores 25 the information. The server 104 may have a TCE as defined in 3GPP.

6. If no GPS info or cell-id is detected, the server 104 can use geo-locating to determine the position of the AP 102 or a cellular node 107 from IP address and/or mobile operator database to correlate building 109 address to IP address (when mobile operator provide fixed access to home).

7. Coverage/traffic volume reports are generated by server 104, cellular signal strength and lack of signal strength are plotted in e.g. a map together with e.g. the number of terminals 101 reporting, amount of data and other collected informations.

8. The information is used by the cellular system operator to decide build-out of new/reuse of AP 102 site for cellular 3GPP coverage improvement etc.

This exemplary method can be installed and managed by the operator, and the terminal 101 only needs to report signal strength from frequencies used by the operator. In another case, a third part 108 can manage the method, and the terminal 101 can report measurements from all frequencies the terminal is capable of. The reporting of terminal capabilities are needed to determine whether there is no coverage or the terminal cannot measure the particular frequency band, if the terminal does not report a signal strength for that band.

### EXAMPLE 2

1. The OAM configures the terminal 101 to measure cellular 3GPP signal strength/signal quality when WiFi is in range. It may also configure the terminal to measure WiFi coverage (such as beacon reception and network name) when connected to cellular 3GPP system. If possible, also position should be measured such as by a global navigation satellite system (GNSS) measurements like GPS or network based positioning measurements like cell-id, beacon id, OTDOA, etc.

2. The terminal 101 sends 3 information via 3GPP connection (using e.g. the procedures defined for MDT or via a user plane connection or via WiFi to a server 104 (e.g. a TCE) like described in first example above.

3. If no GPS info or cell-id is detected, the server 104 can use geo-locating to determine the position of the AP 102 or a cellular node 107 from IP address and/or mobile operator database to correlate building 109 address to IP address (when mobile operator provide fixed access to home).

4. Coverage/traffic volume reports are generated by server 104, cellular signal strength and lack of signal strength are plotted in e.g. a map together with e.g. the number of terminals 101 reporting, amount of data and other collected informations.

5. The information is used by the cellular system operator to decide build-out of new/reuse of AP 102 site for cellular 3GPP coverage improvement etc.

This exemplary method can be installed and managed by the operator, and the terminal 101 only needs to report signal strength from frequencies used by the operator. In another case, a third part 108 can manage the method, and the terminal 101 can report measurements from all frequencies the terminal is capable of. The reporting of terminal capabilities are needed to determine whether there is no coverage or the terminal cannot measure the particular frequency band, if the terminal does not report a signal strength for that band.

The invention has mainly been described above with reference to a few embodiments. However, as is readily appreciated by a person skilled in the art, other embodiments than the ones disclosed above are equally possible within the scope of the invention, as defined by the appended patent claims.

1-24. (canceled)

25. A method at a wireless communication terminal, the method comprising:
detecting whether the terminal is in range of a wireless local network;
measuring, while the terminal is in range of said local network, signal quality of a cell of a first cellular radio access network (RAN), said cell using a first radio access technology (RAT); and
sending information about the measured signal quality to a server, via a second RAT.

26. The method of claim 25, wherein the second RAT is different from the first RAT.

27. The method of claim 25, wherein the second RAT is implemented by the wireless local network.

28. The method of claim 25, wherein the second RAT is implemented by a second cellular RAN.

29. The method of claim 25, wherein the second RAT is the same as the first RAT.

30. The method of claim 25, wherein the wireless local network is in accordance with an Institute of Electrical and Electronics Engineers (IEEE) standard.

31. The method of claim 25, wherein the second RAT is in accordance with a cellular radio communication standard from the group consisting of: Global System for Mobile Communications (GSM), Universal Mobile Telecommunication System (UMTS), Long Term Evolution (LTE), Wideband Code Division Multiple Access (WCDMA), Code Division Multiple Access 2000 (CDMA2000), Interim Standard 95 (IS-95), Ultra Mobile Broadband (UMB), and High-Speed Packet Access (HSPA).

32. The method of claim 25, wherein the method is controlled by a software application installed in the terminal.

33. The method of claim 25, further comprising wirelessly receiving a request for performing the measurement.

34. The method of claim 25, further comprising:
determining a position of the terminal when the signal quality is measured; and
sending information about the determined position to the server.

35. The method of claim 25, further comprising:
determining at least one capability of the terminal; and
sending information about said at least one capability of the terminal to the server.

36. The method of claim 35, wherein said at least one capability is one or a plurality from the group consisting of: RATs supported by the terminal; frequency band(s) the terminal is able to measure on; number of antennas used by the terminal; channel configurations supported by the terminal; and interference cancellation, if any, the terminal is able to use.

37. The method of claim 25, further comprising:
determining a type of the cell, from the group of cell types consisting of: a macrocell, a microcell, a picocell and a femtocell; and
sending information to the server about the determined type.

38. The method of claim 25, further comprising:
determining at least one configuration of the cell, from the group consisting of an open subscriber group cell, a closed subscriber group (CSG), cell, a hybrid cell, a multimedia broadcast multicast service (MBMS), cell, and traffic volume capacity offered by the cell; and
sending information about the determined configuration of the cell to the server.

39. The method of claim 25, further comprising:
determining an amount of at least one of uplink traffic sent by the terminal and downlink traffic received by the terminal, during a time period while the terminal is in range of the wireless local network; and
sending information about the determined traffic amount to the server.

40. A communication terminal for wireless communication, the terminal comprising:
a receiver;
a transmitter; and
a processing circuit cooperatively associated with the receiver and transmitter and configured to:
detect, via the receiver, whether the terminal is in range of a wireless local network;
measure, while the terminal is in range of said local network, signal quality of a cell of a first cellular radio access network (RAN), said cell using a first radio access technology (RAT); and
send, via the transmitter, information about the measured signal quality to a server, via a second RAT.

41. A non-transitory computer-readable medium storing a computer program comprising computer-executable instructions that, when executed by a processing circuit in a communication terminal configured for wireless communication, causes the communication terminal to:
detect, via a receiver included in the communication terminal, whether the terminal is in range of a wireless local network;
measure, while the terminal is in range of said local network, signal quality of a cell of a first cellular radio access network (RAN), said cell using a first radio access technology (RAT); and
send, via a transmitter included in the communication terminal, information about the measured signal quality to a server, via a second RAT

42. A method at a network server node, the method comprising:
sending a request to a wireless communication terminal for the terminal to detect whether said terminal is in range of a wireless local network, and for the terminal to, if it has been detected that the terminal is in range of the wireless local network, measure a signal quality of a cell of a cellular radio access network (RAN);
receiving information about the measured signal quality from the terminal; and
storing said information.

43. The method of claim 42, further comprising:
obtaining an IP address of an access point of the wireless local network; and
establishing a position of the access point based on the IP address.

44. A network server node comprising:
a transmitter configured for sending a message to a terminal;
a receiver configured for receiving information about measured signal quality from the terminal;
a storage unit configured for storing said information; and
a processor configured to:
prepare the message comprising a request to the terminal for the terminal to detect whether said terminal is in range of a wireless local network, and for the terminal to, if it has been detected that the terminal is in range of the wireless local network, measure a signal quality of a cell of a cellular radio access network (RAN);
obtain the information about the measured signal quality from the receiver; and
store the obtained information in the storage unit.

45. The network server node of claim 44, wherein the receiver is further configured to receive information about at least one of a position of the terminal and a capability of the terminal, and the processor is further configured to obtain the position information or the capability information from the receiver and store the obtained information in the storage unit.
